(19) United States
(12) Patent Application Publication
(10) Pub. No.: US 2026/0002411 A1
(43) Pub. Date: Jan. 1, 2026

(54) ACTUATED ROLLER SYSTEMS FOR LADDERS

(71) Applicant: LITTLE GIANT LADDER SYSTEMS, LLC, Springville, UT (US)

(72) Inventors: Aaron Bruce MAJOR, Nephi, UT (US); N. Ryan MOSS, Mapleton, UT (US); Darius S. PENROD, Elberta, UT (US)

(21) Appl. No.: 19/209,595

(22) Filed: May 15, 2025

Related U.S. Application Data
(60) Provisional application No. 63/666,386, filed on Jul. 1, 2024.

(51) Int. Cl. E06C 1/397; E06C 1/39; E06C 7/00; E06C 7/42

(52) U.S. Cl. CPC E06C 1/397; E06C 7/003; E06C 7/423; E06C 1/39

(57) ABSTRACT

A ladder is provided with a pair of rails, a set of braces or rungs extending between the pair of rails, and a roller assembly with a roller movable, via an electronic actuator, between different positions, such as an extended position and a retracted position relative to the rails. The roller can extend below a bottom end of the rail and any connected foot on the rail so that the ladder can roll across a ground surface, or the roller can be retracted to support the ladder using the rail or foot. Other electronic components can be used to sense a user or a condition of the ladder in order to control the extension and retraction of the rollers based on the user or conditions.

### CROSS-REFERENCE TO RELATED APPLICATIONS

This application claims the benefit of U.S. Provisional Patent Application No. 63/666,386, filed 1 Jul. 2024, entitled ACTUATED ROLLER SYSTEMS FOR LADDERS, the disclosure of which is incorporated by reference herein in its entirety.

### TECHNICAL FIELD

The present disclosure generally relates to rollers for ladders and particularly relates to retractable rollers to assist in moving the ladder.

### BACKGROUND

Ladders are an essential tool for enabling workers to reach difficult areas, but they can be difficult and cumbersome to move from place to place. Their size and weight can be tiresome to haul or lift, especially when the ladder needs to be moved many times over the course of a day. Some ladders include wheels to help the user roll the ladder rather than having to carry the ladder, but the wheels often still require the user to reconfigure the ladder, such as by manually deploying and stowing the wheels for each use or by requiring the user to tilt and turn the ladder into unusual angles for the wheels to support the ladder. Thus, even ladders with wheels can be cumbersome to move. For these and other reasons, there is a constant need for improvements to ladders and transportation of other large and tall objects such as scaffolds, trellises, and platforms.

### SUMMARY

One aspect of the present disclosure relates to a ladder, comprising a pair of rails spaced apart from each other, a set of braces coupled to and extending between the pair of rails, and a roller assembly. The roller assembly may comprise a roller coupled with a rail of the pair of rails and movable relative to the rail between a first position and a second position, and an electronic actuator operable to move the roller from the second position to the first position. In the first position, the roller may extend below a bottom end of the rail, and in the second position, the roller may be retracted relative to the first position.

In some examples, the electronic actuator comprises a linear actuator.

In some examples, the electronic actuator is operable to move the roller from the first position to the second position.

In some examples, the ladder further may further comprise an input device coupled to the ladder, wherein the electronic actuator is controllable by input provided to the input device. The input device may comprise a hand sensor, a capacitive sensor, a current sensor, a pressure sensor, an infrared sensor, or a foot switch.

A second roller assembly may be coupled with a second rail of the pair of rails, with the second roller assembly including a second electronic actuator, and the second electronic actuator may be controllable by the input device. The electronic actuator and the second electronic actuator may be simultaneously controllable by the input device.

In some examples, the roller comprises a caster wheel.

In some examples, the electronic actuator comprises a motor operable to produce an audible alert or a haptic alert when the roller is moved via the motor.

Another aspect of the disclosure relates to a ladder, comprising: a rail assembly, including a pair of rails spaced apart from each other, a set of braces coupled to and extending between the pair of rails, and a logic unit; and a roller assembly, including: a roller coupled to the rail assembly and movable relative to the rail assembly between an extended position and a retracted position, and an actuator coupled with the roller and operable, via the logic unit, to move the roller between the extended position and the retracted position.

In some examples, the logic unit comprises a processor and a computer-readable memory device comprising executable instructions that, when executed by the processor, cause the processor to deploy the roller from the retracted position to the extended position.

In some examples, the roller is biased toward the retracted position.

In some examples, the actuator comprises a clutch operable by the logic unit.

In some examples, the roller is configured to rotate about a vertical axis and the actuator is configured to move the roller between the extended position and the retracted position parallel to an axis non-parallel to the vertical axis.

Yet another aspect of the disclosure relates to a ladder foot assembly, comprising: a mount; a carrier coupled with the mount and movable relative to the mount between a first position and a second position; a roller rotatably coupled with the carrier and movable with the carrier between the first position and the second position; and an electronic actuator operable to move the carrier relative to the mount between the first position and the second position.

In some examples, the electronic actuator is configured to linearly move the roller between the first position and the second position.

In some examples, the ladder foot assembly further comprises a sensor in electronic communication with the electronic actuator, wherein the electronic actuator is configured to move the carrier in response to a signal from the sensor.

In some examples, a longitudinal axis of the carrier is configured to be non-vertical when the roller is positioned on a horizontal ground surface.

The above summary of the present invention is not intended to describe each embodiment or every implementation of the present invention. The Figures and the detailed description that follow more particularly exemplify one or more preferred embodiments.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is a perspective view of a ladder.

FIG. 2 is a perspective view of a foot area of the ladder of FIG. 1 with a roller retracted.

FIG. 3 is a perspective view of the foot area of FIG. 2 with the roller extended.

FIG. 4 is a right side view of the foot area of FIG. 2 with the roller extended.

FIG. 5 is a right side view of the foot area of FIG. 2 with the roller retracted.

FIG. 6 is a schematic diagram of and electronic system for a ladder.

FIG. 7 is a partial front view of the ladder of FIG. 1 with electronic components schematically indicated.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

As mentioned above, wheeled ladders can be cumbersome, frustrating, or time-consuming to safely use and transport. Wheeled ladders have been devised, as in U.S. Provisional Patent Application Nos. 63/611,043 and 63/325,995, and U.S. patent application Ser. No. 18/194,146 (the entire disclosures of all three of which are hereby incorporated by reference), to move ladders across surfaces more readily and easily. Some embodiments provided in those applications include easily or automatically retractable wheels to help alleviate these issues. Their wheels may be spring loaded and biased to support rolling movement of the ladder when the wheels are extended while also being retractable when sufficient weight is applied to the ladder. For large or heavy ladders, the spring forces must be great enough to keep the wheels extended under the weight of the ladder alone but not so great that the wheels will not sufficiently retract when weight (e.g., a user's weight) is added to the ladder. Additionally, some ladders are large enough that standing on one set of rungs of the ladder (e.g., front rungs) might not apply enough downward force on retractable wheels on the other side of the ladder (e.g., the rear side) to retract those other wheels, thereby leading to instability or unwanted movement while a user climbs the ladder. Thus, spring tolerances and design considerations, in addition to ladder sizing and wheel placement, can limit the size and weight of ladder to which a retractable wheel can be added for effective use. The wheels could be manually retracted by the user, but doing so can be cumbersome and time-consuming, especially if the wheels need to be adjusted frequently.

Ladders of the present disclosure may include rollers (e.g., wheels) that are configured to extend and retract in response to operation of electronic actuators. The electronic actuators can be operated by the user via a user interface or input device (e.g., a handle, button, or user sensor) that is easily accessible to the user while he or she uses the ladder. The actuators can actuate movement of multiple rollers simultaneously, such as by moving a roller at each foot of each rail of the ladder at the same time. In this manner, the ladder may transition quickly and efficiently between rollable and stationary states, thereby improving mobility of the ladder as a whole.

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

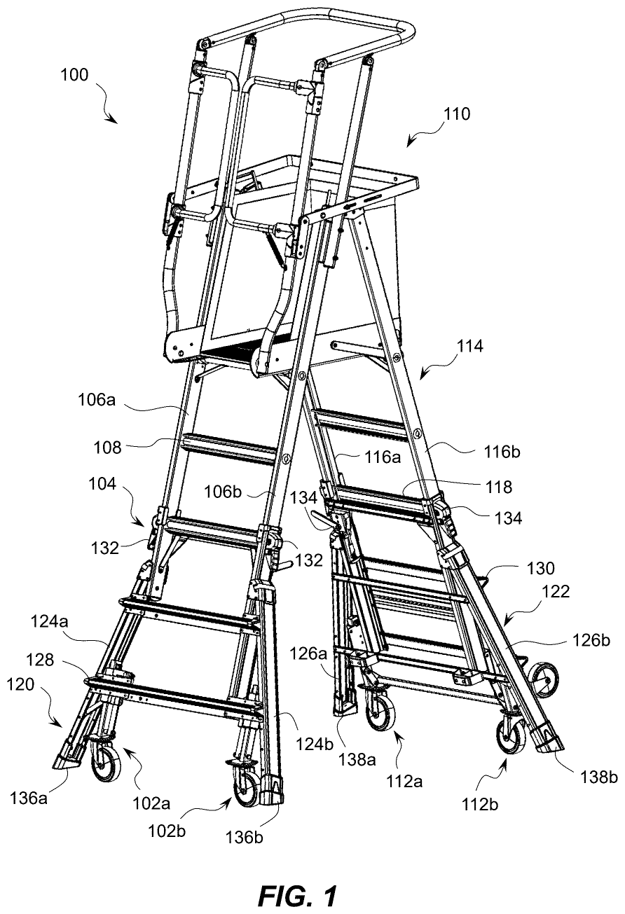

FIG. 1 is a perspective view of a ladder 100 with retractable roller assemblies 102a, 102b (collectively 102) and 112a, 112b (collectively 112), which in some examples may be referred to as extendable rollers, movable caster assemblies, actuated wheels, or rollable foot assemblies. The ladder 100 can be referred to as a ladder assembly and is representative of various types of elevated platforms, such as step stools, scaffolds, trestles, and similar devices, all of which may be used in place of ladder 100. The ladder 100 can include a first assembly 104 including a first pair of rails 106a and 106b (collectively referred to as rails 106) spaced apart from each other. The first assembly 104 can include a first set of horizontal members, braces, steps, or rungs 108 extending between and coupled to the first pair of rails 106a and 106b.

In at least one example, the ladder 100 can include a second assembly 114 including a second pair of rails 116a and 116b (collectively referred to as rails 116) spaced apart from each other. The second assembly 114 can include a second set of horizontal members such as horizontal braces, steps, or rungs 118 extending between and coupled to the second pair of rails 116a and 116b.

The second pair of rails 116a and 116b can be rotatably coupled with the first pair of rails 106a and 106b. In some examples, the second pair of rails 116a and 116b can rotate about a rotational axis coinciding with a hinge, such as a hinge formed in or by a top cap or top step of the ladder 100. In some embodiments, the ladder 100 may not include a top cap, and at least one hinge can directly pivotally couple pairs of rails (e.g., 106a, 116a or 106b, 116b), such as in an articulating or combination ladder that is configurable into a freestanding, extension/straight, and collapsed configuration. In some embodiments, the assemblies 104, 114 can include a top platform assembly 110 with linkages configured to pivotally couple the rails 106, 116. The top platform assembly 110 may include a standing platform, railing or handles, a gate, and related components to enable a person to stand on the ladder at an elevated position with bracing supports around himself or herself. Thus, the ladder 100 of FIG. 1 is illustrative of only one example application of the principles and features disclosed herein, and roller assemblies can be applied to various types of ladders.

The ladder 100 may comprise a third assembly 120 (i.e., an outer front assembly) slidably coupled with the first pair of rails 106. Similarly, a fourth assembly 122 (i.e., an outer rear assembly) can be coupled with the second pair of rails 116. The third assembly 120 and fourth assembly 122 may respectively comprise outer rails 124a, 124b, 126a, 126b and outer rungs 128, 130. The front outer rails 124 may be movable relative to the inner rails 106 of the first assembly 104, and the rear outer rails 126 may be movable relative to the inner rails 116 of the second assembly 114, thereby enabling overall height adjustment of the ladder 100. The outer rungs 128, 130 may be offset from the inner rungs 108, 118 so that the assemblies 104/120 and 114, 122 do not interfere as they slide between different longitudinal length positions. A set of adjustment mechanisms or locks 132, 134 can adjustably and releasably retain the assemblies in different relative length positions.

Pairs of feet 136a, 136b (collectively 136) and 138a, 138b (collectively 138) can be positioned at respective bottom ends of the outer rails 124, 126. The pairs of feet 136, 138 can support the ladder 100 against a ground surface while the roller assemblies 102, 112 are in retracted positions. When the roller assemblies 102, 112 are extended, the roller assemblies 102, 112 can extend below the pairs of feet 136, 138 and can therefore support the ladder 100 instead of the pairs of feet 136, 138, as described in further detail below.

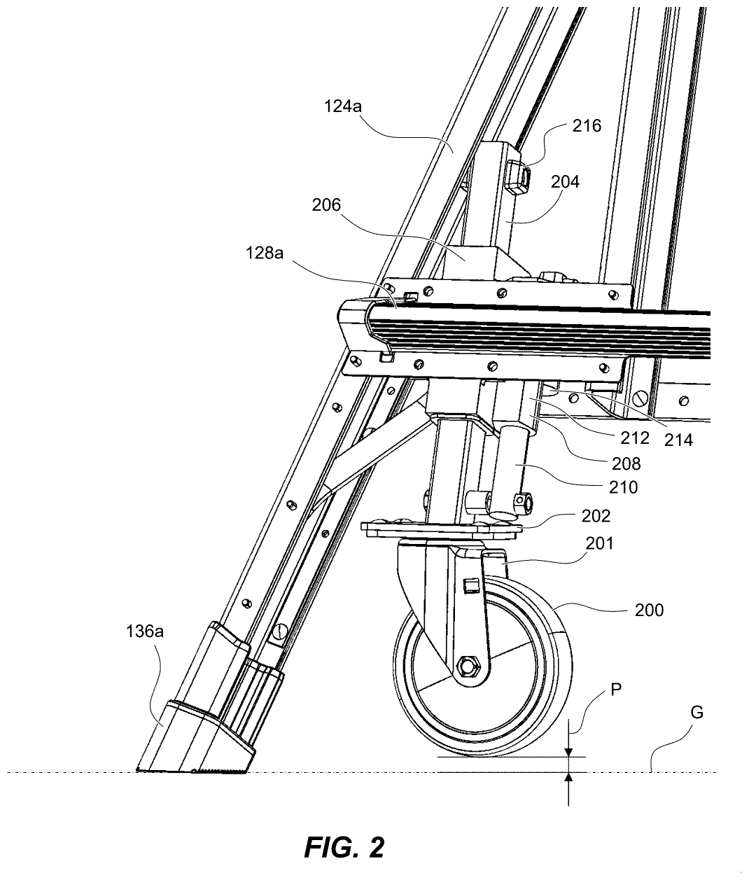

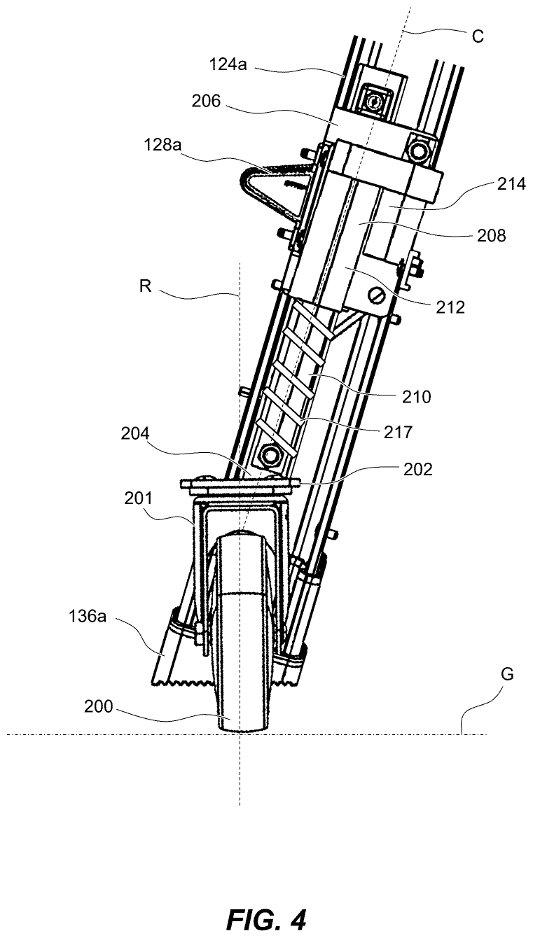

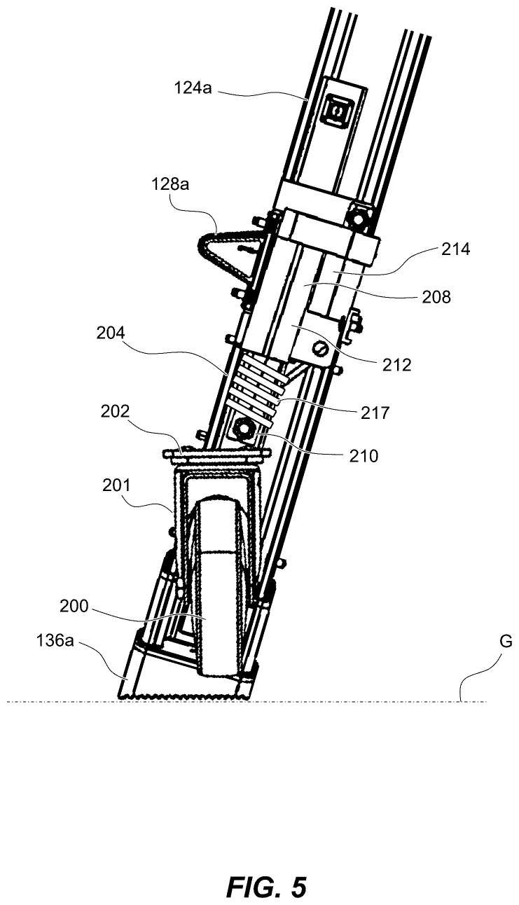

As shown in FIGS. 2-5, the retractable roller assemblies 102, 112 can include a roller 200, a roller bracket 202, a carrier 204, a mount 206, and an electronic actuator 208. In some embodiments, the roller assemblies 102, 112 can optionally include springs or other biasing mechanisms configured to bias their respective rollers 200 to retracted positions. See FIGS. 4-5. The roller assemblies 102, 112 can be respectively directly coupled to outer rungs 128, 130 of the third and fourth assemblies 120, 122. In some examples, the roller assemblies 102, 112 can be respectively directly coupled to outer rails 124, 126, inner rails 106, 116, or inner rungs 108, 118.

The roller assemblies 102, 112 can be mounted to the ladder 100 in pairs, wherein a first pair of roller assemblies 102 is positioned on the first assembly 104 and a second pair of roller assemblies 112 is positioned on the second assembly 114. In some embodiments, a ladder can therefore include two pairs of roller assemblies, or one roller assembly per corner of the ladder 100 when the ladder is in a free-standing configuration (e.g., as shown in FIG. 1). In some embodiments, a ladder can include one pair of roller assemblies (e.g., on only the first assembly 102 or only on the second assembly 112), or more than two roller assemblies can be positioned on either assembly 102, 112.

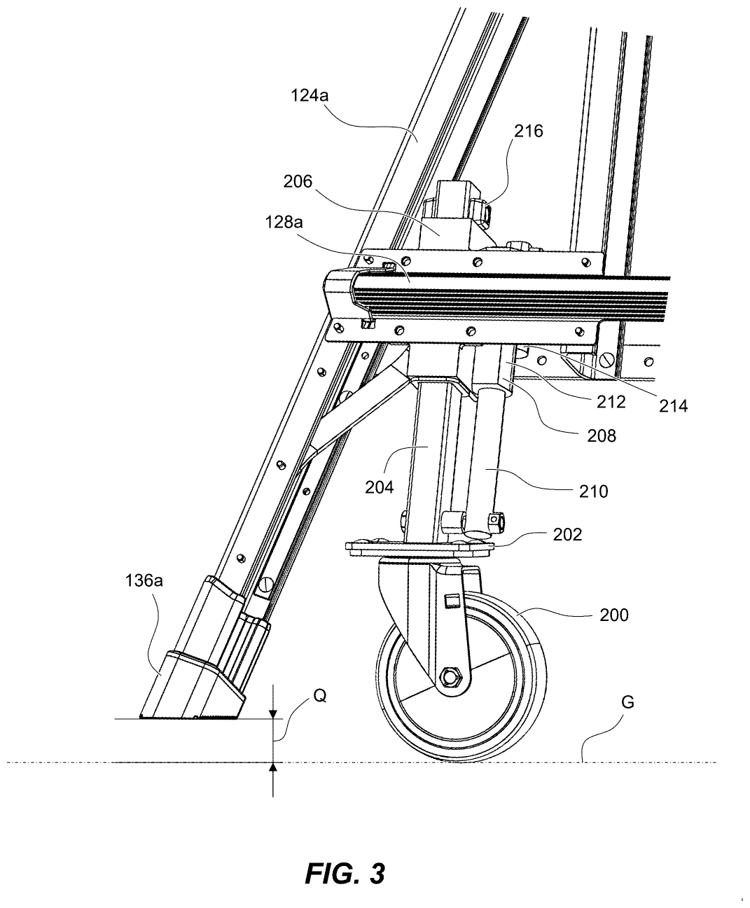

Each roller assembly 102, 112 can be configured to extend and retract its respective roller 200 relative to the mount 206 using the electronic actuator 208 and the carrier 204. Thus, each roller assembly 102, 112 may be operable to move a roller 200 from a retracted position relative to a foot 136, as shown for example in FIGS. 2 and 5, to an extended position relative to the foot 136, as shown in FIGS. 3 and 4. When in a retracted position, the roller 200 can have its bottom tip surface held at or above the ground surface G. Thus, in some cases, a gap P may be formed between the bottom of the roller 200 and the ground surface G, and the foot (e.g., 136a) may be in contact with the ground surface G. While the roller assemblies 102, 112 are in their retracted positions, engagement of the feet 136, 138 with the ground surface G can prevent sliding movement of the ladder 100 across the ground surface G. Accordingly, with the rollers 200 in their retracted positions, the ladder 100 can be referred to as being in a foot-supported configuration or a stationary configuration.

When in an extended position, the roller 200 can have its bottom surface engaged with the ground surface G and extending below the bottom of the adjacent foot (e.g., 136a). The bottom surface of the foot 136 can be spaced away from the ground surface G by a gap Q, as shown in FIG. 3. While the roller assemblies 102, 112 are in their extended positions, engagement of the rollers 200 with the ground surface G can enable rolling movement of the ladder 100 across the ground surface G. In some embodiments, the ladder 100 can thereby be rolled without (or with substantially reduced) sliding resistance or friction between the feet 136, 138 and the ground surface G.

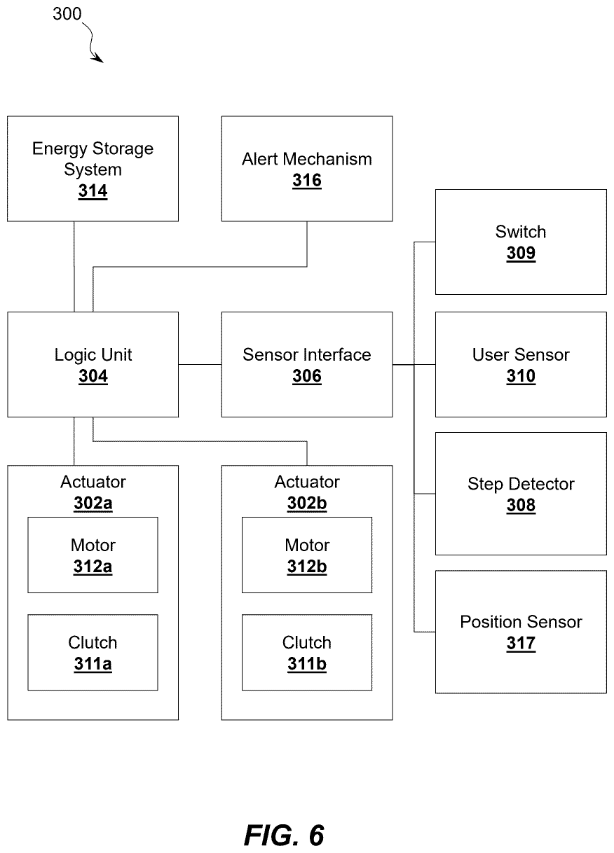

The roller assemblies 102, 112 can be transitioned between retracted and extended configurations by the electronic actuators 208. The electronic actuators 208 may drive the carrier 204, roller bracket 202, and roller 200 between the retracted and extended configurations. The electronic actuators 208 may comprise motors, mechanical or electromechanical linear actuators, driven gear systems (e.g., rack and pinion), coiled actuators, pneumatic actuators, hydraulic actuators, other electronically-driven actuators, or combinations thereof. Thus, the actuators 208 can be configured to linearly displace the rollers 200 along an axis of actuation or a longitudinal axis of motion C between different configurations. See FIG. 4. In some embodiments, the electronic actuators 208 can include rotational actuators (e.g., a driven cam wheel to which the roller 200 is coupled and by which the roller 200 is rotated between extended and retracted positions relative to a nearby foot (e.g., 136a)). As shown in the example of FIGS. 2-6, the electronic actuators 208 can each include a driving bar 210 coupled to a carrier 204 and configured to apply a force to the carrier 204 to move the roller 200. The driving bar 210 may be driven by an electric motor 212 (or motors 312a, 312b in FIG. 6), gear system, or other driver system. The electric motor 212 can be electrically coupled with a power source 214 (e.g., a battery bank or energy storage system 314 of FIG. 6). In some embodiments, each motor 212 may be coupled with a respective power source 214, and in some cases, the motors 212 may be coupled to a common power source, such as a single battery bank positioned on the ladder 100. In some embodiments, the electronic actuators 208 can be coupled with the mounts 206 and/or directly coupled with a rung (e.g., 128a) of the ladder 100.

The electronic actuators 208 can be configured to apply a force to the rollers 200 sufficient to lift the feet 136, 138 of the ladder 100 away from the ground surface G when needed. Thus, the electronic actuators 208 can be collectively configured to lift the entire weight of the ladder 100. In some embodiments, some actuators 208 can be configured to apply a greater lifting force than other actuators 208 on the same ladder 100 based on the weight distribution of the ladder 100, wherein rollers 200 expected to hold more of the weight of the ladder 100 (e.g., on average) can be driven with greater force by their respective actuators 208 than other rollers 200.

The electronic actuators 208 can also be configured to quickly withdraw or retract the rollers 200 from an extended configuration. For example, the actuators 208 can withdraw rollers 200 within about 1 second or less. In this manner, the actuators 208 can be used to substantially immediately withdraw or retract rollers 200 if a person is detected stepping onto the ladder 100, thereby rapidly transitioning the ladder to a state supported by the feet 136, 138 instead of (or, in some cases, in addition to) being supported only by the rollers 200. In this manner, the ladder 100 can be resistant to unpredictably rolling (e.g., due to contact between the feet 136, 138 and the ground surface G) as a person ascends the ladder 100.

The roller 200 can comprise a wheel, caster wheel, ball wheel, similar structure, supporting structures, or combinations thereof. The roller 200 can be configured to roll while supporting the ladder 100 against a ground surface G, as shown in FIGS. 3 and 4. The roller 200 can have a size (e.g., diameter) configured to roll across a ground surface with minor imperfections or irregularities, such as a floor of a construction site. The roller 200 can be rollable about a fixed axis of rotation (e.g., via being mounted on a bracket 201/202). The lower portion 201 of the bracket can be rotatably mounted to an upper portion 202 which is fixed to the carrier 204, and the lower portion 201 can be rotatable relative to the upper portion 202 about a vertical axis of rotation R (see FIG. 4). The axis of rotation R can be angularly offset from a longitudinal axis C (see FIG. 4) of the carrier 204. Thus, the roller 200 can be operable to roll on the ground surface G without being biased toward any particular direction or orientation relative to the vertical axis of rotation R.

The roller bracket 201/202 can directly couple the roller 200 to the carrier 204. The roller bracket 201/202 can couple the roller 200 and carrier 204 at an angle (e.g., the acute angle between axes R and C) to ensure that the roller 200 flatly engages the ground surface G while the rails (e.g., 124a) are non-vertically angled (e.g., aligned with axis C). For this reason, the ladder 100 can remain in a freestanding configuration (e.g., as shown in FIG. 1) while the rollers 200 are extended and supporting the ladder 100 or while the rollers 200 are moved from a retracted position to an extended position. Furthermore, while in the freestanding configuration, the rollers 200 can remain in their angularly offset orientation (i.e., with an acute non-zero angle between axes R and C, as shown in FIG. 4) as they move between the extended and retracted positions.

The carrier 204 can comprise a rigid member slidably coupled to the mount 206 and configured to support the roller 200 and bracket 201/202. In some embodiments, the carrier 204 can include a stop portion or limiting bumper 216 (see FIGS. 2-3) configured to mechanically interfere with the mount 206 in a manner limiting the range of motion of the carrier 204, such as, for example, to prevent the carrier 204 from overextending relative to the mount 206.

Furthermore, a spring or other biasing member (e.g., 217) can be arranged on, within, or around the carrier 204 and/or driving bar 210. See FIGS. 4 and 5 (the spring or biasing member 217 is omitted from FIGS. 1-3). The spring or biasing member 217 can apply a biasing force to the carrier 204 or driving bar 210 (e.g., via the bumper 216) to bias the roller 200 into a retracted position (e.g., FIG. 5) when it is not being positively driven and held by the motor 212 in an extended position (e.g., FIG. 4). Thus, for example, the spring or biasing member 217 can comprise an extension spring when positioned below the actuator 208 or rung 128 or can comprise a compression spring when positioned above the actuator 208 or rung 128. The spring or biasing member 217 can thereby bias the ladder 100 into a condition where it will not be stuck in a roller-extended configuration in the event of power loss, motor failure, or other unusual or emergent conditions.

In some configurations, the carrier 204 and the driving bar 210 can be integrated together as a single rigid member. For example, the electric motor 212 can be configured to drive movement of the carrier 204 instead of driving movement of a separate driving bar 210. In this case, the assembly can be simplified when the motor 212 and carrier 204 are compatible. However, a carrier 204 and driving bar 210 may be separately included in embodiments (e.g., FIGS. 2-5) where the motor 212 is configured to drive a smaller bar (210) and the rigid member of the carrier 204 is provided for reinforcement and rigidizing the assembly or using different materials from the driving bar 210.

The mount 206 can be directly coupled to a rung (e.g., 108, 118, 128 or 130) or rail (e.g., 106, 116, 124, 126) of the ladder 100. The mount 206 can beneficially be positioned at a bottom end of the ladder 100 so as to minimize the travel distance of the roller 200 between extended and retracted positions. In some embodiments, the mount 206 can be positioned within or configured as an integrated part of the rail (e.g., 106), wherein the roller 200 is extendable and retractable through the bottom surface of the foot thereof (e.g., 136).

The mount 206 can comprise a bracket with a central opening for slidably receiving and retaining the carrier 204. The mount 206 can also be coupled with an actuator 208 to join the actuator 208 to a rung or rail. With the mount 206 as the primary or only part connecting the actuator 208 and roller 200 to the ladder 100, the ladder 100 can be easily modified to add the functionality of the roller assemblies 102, 112 to various rungs or rails since only a single part (i.e., the mount 206) needs to be attached to an existing rung or rail, and therefore minimal damage or changes to an existing ladder 100 are needed.

FIG. 6 is a schematic diagram illustrating components of the ladder 100 that may be part of an electrical system 300 to enable control and monitoring of the operation of electronic actuators 208 and other ladder states. For example, the electrical system 300 may include one or more actuators 302 (e.g., first actuator 302a, second actuator 302b, and any number of additional actuators) coupled to rollers and configured to move the rollers in a manner similar to the actuators of retractable roller assemblies 102. The actuators 302 can be in electronic communication with a logic unit 304 (e.g., a controller, computer, central processing unit, and/or computer-readable memory device or memory unit) mounted to the ladder 100. The system 300 can also include a sensor interface 306 coupled with one or more switches 309, user sensors 310, step detectors 308, and/or position sensors 317. The system 300 can also include one or more energy storage systems 314 and one or more alert mechanisms 316.

The logic unit 304 can be configured to control the operation of the actuators 302 and to thereby control the positioning of the rollers coupled to the actuators 302. The logic unit 304 can control the actuators 302 in response to signals detected via the sensor interface 306, such as by detecting operation of the switch 309, detecting a change in capacitance or current via the user sensor 310, or detecting a step using the step detector 308. The logic unit 304 can therefore provide control signals to one or more motors 312 (e.g., a motor for each actuator 302, such as a first motor 312a and a second motor 312b) and/or clutches 311 (e.g., a clutch for each actuator 302, such as a first clutch 311a and a second clutch 311b). The logic unit 304 can comprise a memory device having electronic instructions encoded thereon that, when executed by a processor, can control the states of the actuators 302, such as by controlling the direction and speed of rotation of the motors 312 and an engagement status of the clutches 311. In some configurations, the logic unit 304 is configured to simultaneously operate and control all actuators 302a, 302b of the system 300. In some embodiments, the logic unit 304 can be configured to operate groups or subsets of the actuators 302 (e.g., front actuators only or rear actuators only), and in some cases, the logic unit 304 can switch between states, e.g., from controlling all actuators 302 to controlling subsets thereof based on user input or user operation of various sensors or input devices.

The motors 312 can comprise electric motors (e.g., brushed or brushless/induction-type, stepper motors, DC motors, AC motors, similar devices, and other motors known by those having skill in the art and the benefit of the present disclosure) configured to drive gears or other mechanical components of the actuator 302 or their related retractable roller assembly 102. For example, the motors 312 can be the motors 212 indicated above, and the motors 312, when driven, can induce linear movement of a driving bar 210 to thereby control the positioning of a roller 200 relative to the foot 136 or ground surface G.

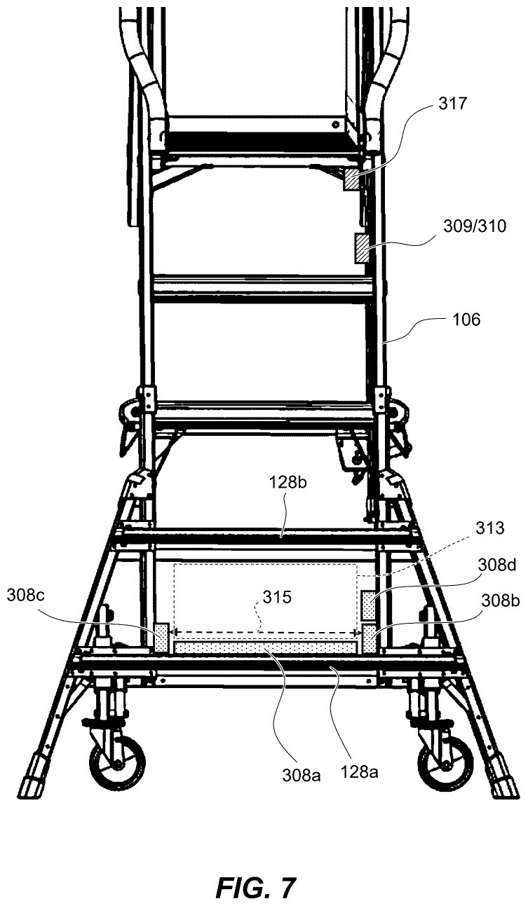

The switch 309 can comprise an input device (e.g., a mechanical or electrical switch) configured to trigger or actuate in response to user input. For example, the switch 309 can include a mechanical switch configured to change states when a user presses the switch. In some embodiments, the user can press the switch by grasping a portion of the ladder 100 such as a handle or rail on the ladder 100. FIG. 7 illustrates an example embodiment of the ladder 100 in which an example switch 309 is indicated and located on an inner side of a front rail (e.g., 106). Thus, as a user approaches the ladder 100 with intent to climb into the rungs, the switch 309 can be positioned at a comfortable height in front of the user such that he or she will see and be capable of reaching and actuating the switch 309 using his or her hand when reaching for the rail 106 in a normal, upright walking movement or standing position. For example, the switch 309 can be positioned at about 3-4 feet away from the ground surface G when the ladder 100 is upright and standing. In some embodiments, the switch 309 can be positioned on a rail that does not greatly change its position relative to the ground surface G, or a rail that does not slide relative to the upper rail 106, such as an outer rail 124 or a leg extending therefrom. Accordingly, the vertical position of the switch 309 can be kept substantially consistent when the ladder is standing, irrespective of the length of the front and rear assemblies of the ladder 100.

In some examples, the switch 309 can comprise a button, toggle, lever, or key to be pressed or otherwise manipulated by the user. Thus, the switch 309 can comprise an actuated or depressed state and an unactuated or undepressed state. The switch can be configured to sense a force or pressure applied to the switch 309, such as when a user grasps the rail and presses a button for the switch 309. In that case, the switch can output or enable a signal detectable at the logic unit 304 to operate a function of the ladder 100. The switch 309 can be biased to the unactuated or undepressed state. In other cases, the switch 309 can be a toggle switch or bistable switch, wherein the switch has two stable states, either of which can be detected by the logic unit 304. Furthermore, the switch 309 can comprise various other types of input devices, such as, for example, a dial, slide switch, toggle switch, rotary switch, similar switches, and combinations thereof.

Operating the switch 309 can provide a signal to the logic unit 304 to control the motors 312 and/or clutches 311 and to thereby control the positioning of the rollers 200. For example, for a depressible button switch, pressing the switch can trigger extension of the rollers 200 from a retracted state to a deployed state, thereby allowing the user to conveniently roll the ladder 100 across the ground surface G. Releasing the switch 309 can trigger retraction of the rollers 200 back to a retracted state by the actuator 302, thereby making the feet (e.g., 136) engage the ground surface G and thereby reduce or prevent sliding or rolling movement of the ladder 100 on the ground surface G. This can also help limit unwanted movement of the ladder, such as when the user is loading or standing on the ladder or when the user's hand slips from the switch, since releasing the switch 309 immediately transitions the ladder to a foot-supported state that would brake sliding movement.

In some embodiments, the switch 309 may extend the rollers when pressed and released one time and may then retract the rollers when pressed and released a second, successive time. Thus, the switch 309 can be used to toggle the state of the rollers. In this case, the switch 309 may comprise a limit switch, wherein power is not required to be continuously applied to the actuator to keep the state of the roller 200 consistent. Additionally, operation of the switch 309 can cause the rollers to be extended temporarily, such as for one minute after each actuation of the switch 309 before the rollers are automatically retracted.

In some embodiments, a clutch 311 can be used in conjunction with the switch 309 to help control the movement of the rollers. The clutch 311 can be operable to engage or disengage the driving bar 210, carrier 204, or similar support member coupled with a roller 200. When engaged, the clutch 311 can prevent movement of the support member relative to the foot 136, and when disengaged, the clutch 311 can permit such movement. The clutch 311 can be operable based on the power state of the logic unit 304, motor 312, energy storage system 314, or other related electrical component of the system 300. When power to the system is off, e.g., when the energy storage system 314 is disconnected, switched off, or out of power, or when the logic unit 304 is shut down, the clutch 311 can be configured to automatically disengage, and the roller can then be permitted to freely move relative to the rail. In that case, the roller would retract since the weight of the ladder would urge the roller to move upward relative to the foot. Thus, the clutch 311 can be included as a feature to ensure the ladder 100 does not remain in a rolling state in the event of a power failure or an interruption in the signal to the logic unit 304.

In some embodiments, the user sensor 310 can be implemented in addition to, or in place of, the switch 309. The user sensor 310 can be another type of input device. In some embodiments, the user sensor 310 can comprise a plate or panel configured to sense a change in capacitance, resistance, or current caused by a user's appendage coming near or into contact with the user sensor 310. The user sensor 310 can therefore comprise a capacitance sensor or capacitive plate affected by an electric field emitted by a nearby user. The user sensor 310 can include an ammeter or ohmmeter to determine a change in current or resistance caused by contact between the user sensor 310 and the user. The signal from the user sensor 310 can be used by the logic unit 304 to determine whether to extend or retract the rollers 200. When a user is not detected by the user sensor 310, the rollers can be retracted, and when the user is detected, the rollers can be extended. The user sensor 310 can permit detection of the user even if the user does not directly operate or manipulate the user sensor 310 (e.g., as he or she would do with the switch). Accordingly, the user sensor 310 can be referred to as passively, remotely, wirelessly, or indirectly detecting aspects of the user or the user's position or status.

For example, in some embodiments, the user sensor 310 can comprise a light sensor, imaging device, or camera configured to determine where a user is positioned relative to the ladder 100. The light sensor, imaging device, or camera can be directed away from the rail 106 toward the ground surface G in front of the bottom-most rung 128a or toward an area directly above that area of the ground surface G so that the position of the user can be identified when they are in front of the rung 128a and capable of stepping onto the rung 128a or capable of grasping the rails 106 (e.g., one rail or both rails simultaneously) to move the ladder 100 via the rollers 200. Thus, when the user is in a position such as these, which are correlated with moving the ladder across a ground surface G, the signal from the user sensor 310 can be used to operate the actuators 302 to extend the rollers 200. When the user is out of one of those positions or is not detected in one of those positions, the rollers can be retracted. To illustrate, the light sensor or camera of a user sensor 310 can detect whether the sensor is covered by the user (e.g., covered by the user's hand) to determine whether the user is grasping a particular portion of the ladder 100. In another example, the signal from a camera-based user sensor 310 can be provided to an object or user detection algorithm of the logic unit 304 to determine the status of the user relative to the ladder 100, such as the direction the user is facing, the positions of his or her arms and legs, his or her stance or apparent center of gravity, whether he or she appears to be trying to grasp, pull, push, or otherwise move the ladder, etc. The rollers 200 can be actuated to extend in situations where the intent of the user appears to be to move the ladder, and the rollers 200 can be withdrawn where no such intent is apparent via the user sensor 310.

The step detector 308 can comprise a sensor or switch configured to detect the foot position of the user relative to the ladder 100. For example, the step detector 308 may comprise a mechanical pressure switch (e.g., foot switch 308a in FIG. 7) configured to trigger in response to a user stepping onto a rung 128a. In some embodiments, an electronic switch or detector can be used, such as a load cell, pressure sensor, strain gauge, or a resistance measurement device that is configured to measure or sense the presence of a user or weight on the rung 128a. For example, with an electronic switch or detector, the step detector 308 can measure a force applied to the step detector 308 or to the rung 128a, can measure a strain in the detector or rung, and/or can measure a resistance (or change in resistance) in the detector or rung. Thus, the step detector 308 can be referred to as an input device.

Furthermore, in some configurations the step detector 308 can comprise a light-based sensor, such as an infrared emitter (e.g., at step detector 308b) and detector (e.g., at step detector 308c) or a structured light projector. In some embodiments, the step detector can comprise an emitter and a receiver (e.g., both at 308b), and step detector 308c can comprise a reflector, wherein light from the emitter at step detector 308b reflects from the reflector at step detector 308c and is detected by the receiver at step detector 308b. The step detector 308 can therefore emit light from step detector 308b that is directed toward step detector 308c and which is interruptible or blockable by a user stepping onto the ladder 100, in which case the position of the user is detected in response to determining that the light is interrupted or blocked. Thus, the step detector 308 can determine the position of an object (or user) on or above the rung 128a. Since user contact with the rung is not required for detection, the step detector 308 can determine that user contact with the rung is imminent before the user reaches the rung with their foot or shoe.

In some examples, the step detector 308 can comprise an imaging device 308d such as a camera. The imaging device 308d can be positioned relative to a rung 128a (e.g., the lowermost rung of the assembly) so that the field of view of the imaging device is capable of detecting the presence and/or position of a foot or other user element on or near the rung 128a. The imaging device 308d can have a field of view facing away from the rail 106 toward the center of the rung 128a or across the rung 128a toward the opposite rail 106. Thus, the field of view of the imaging device 308d can include a zone 313 in which a user is expected to move in order to step onto the ladder 100. The zone 313 can be bounded by rails 106 and the lowermost two rungs 128a, 128b of the ladder 100 that are adjacent to the imaging device 308d. The signal from the imaging device 308d can be provided to the logic unit 304, and at least one image recognition algorithm can be used with the signal from the imaging device 308d to detect shapes such as feet, shoes, tools, clothing, or other objects that may indicate the presence of the user and/or his or her intent to climb the ladder 100. The signal from the imaging device 308d can be processed over time (e.g., as a video or image stream) to determine whether the user is climbing onto or descending from the rung 128a or to determine whether user contact with the rung is imminent, even if the user has not yet contacted the rung 128a (e.g., the user is coming down from rung 128b).

Multiple different kinds of step detectors 308 can be used in a single ladder 100 to provide redundancy, overlapping sensor coverage, or an ability to determine user interaction that is not afforded by a single kind of step detector 308. For instance, the step detector 308 can include a pressure switch or strain gauge (e.g., at 308a) and a light-based detector or imaging device (e.g., as step detectors 308b and/or 308c). The signals from multiple kinds of step detectors 308 can be referenced to reduce false negatives and to provide additional reliability to the step detection ability of the ladder 100 in case one of the step detectors 308 is damaged, disabled, or interrupted.

The output of the step detector 308 may be used to control the actuators 302. For example, when movement (or imminent movement) of a user onto a rung 128a is detected via a step detector 308, the logic unit 304 can control the actuators 302 to withdraw or retract the rollers 200. Thus, when the user moves his or her weight onto the rung 128a, the ladder 100 will be in a stable, non-rolling configuration that improves ease of use of the ladder 100. In some embodiments, the logic unit 304 can also determine via the step detector 308 that a user is not positioned on or near the rung 128a and can extend the rollers 200 via the actuators 302.

The energy storage system 314 can comprise a battery positioned on and carried by the ladder 100 and other components to enable its use and function, such as an inverter, charging electronics, and similar devices known in the art. Thus, the ladder 100 can be portable and can power its electronic components without needing a continuous utility grid connection. In some embodiments, the energy storage system 314 can be replaced with or supplemented by components used to connect the electronic components of the ladder 100 to a utility grid connection, such as adapters and connectors configured to charge a battery or to connect the electronic components to be powered directly by the utility grid connection. In some embodiments, the energy storage system 314 can include a removable portion such as a removable battery to facilitate recharging separately from the ladder 100 and/or replacement of the battery with a charged battery so that work interruptions due to power loss can be minimized.

The alert mechanism 316 can be operated by the logic unit 304 to provide output to people near the ladder 100. In various embodiments, the alert mechanism 316 can comprise an audio alert device (e.g., a loudspeaker, buzzer, or chime), a visual alert source (e.g., a bulb, light-emitting diode (LED), or display screen (e.g., liquid crystal display or LED display)), or a haptic feedback device (e.g., a vibrator). In some embodiments, the alert mechanism 316 can be integrated with, or an integral part of, the actuator 302. For example, a motor 312 can be operated with the clutch 311 disengaged (or engaged, in some cases) to provide audible or tactile (e.g., vibration) feedback to a user of the ladder 100. The actuator 302 therefore can serve a dual purpose of moving a roller 200 and acting as an alert mechanism 316.

The alert mechanism 316 can be configured provide output in response to user interaction with the ladder 100 or in response to detecting the state of the ladder. For example, the alert mechanism 316 can provide feedback in response to the actuators 302 moving a roller 200 (e.g., extending or retracting them) to help inform nearby persons that the ladder 100 is now in a more (or less) mobile condition. Similarly, an alert can be generated by the alert mechanism 316 in response to operation of the switch 309, user sensor 310, or step detector 308 so that the user is aware that their input or presence has been detected by the logic unit 304. In various examples, the alert mechanism 316 can be used to provide other ladder status information, such as information about the state of charge of a battery of the energy storage system 314, maintenance alert information (e.g., for the motors), system faults or errors detected by the logic unit 304 (e.g., a stuck clutch 311 or switch 309), or information about the ladder itself (e.g., the number of work cycles of various components of the ladder or ladder/component serial numbers).

In some embodiments, the ladder 100 can optionally comprise a position sensor 317 connected to the sensor interface 306. The position sensor 317 can include one or more tilt sensors, gyroscopes, accelerometers, or other similar sensors/input devices used to determine the position or orientation of the ladder 100 relative to the ground surface G, relative to the user, and/or relative to gravity. The position sensor 317 can be positioned at an upper end of the ladder 100, such as near an upper (e.g., top) rung or top cap, in order to improve its sensitivity to movements of the ladder 100. See, e.g., FIG. 7. Signals produced using the position sensor 317 can be provided to the logic unit 304 to control the actuators 302, other devices connected to the sensor interface 306, and alert mechanism 316.

For example, in some embodiments, the logic unit 304 may control a position of a roller 200 by operating an actuator 302 in response to a signal from the position sensor 317. If the orientation or position of the ladder 100 is sensed as not suitable for rolling on the rollers 200, such as if the ladder 100 is not upright, the logic unit 304 can retract the rollers 200 (e.g., in response to a tipping or falling over of the ladder 100) or can prevent the rollers 200 from extending (e.g., if the rollers 200 are already retracted and the user attempts to extend them using the switch 309, user sensor 310, etc.). Preventing the rollers 200 from extending can include disabling the switch 309, user sensor 310, or step detector 308. If the orientation or position of the ladder 100 is suitable for usage of the rollers 200, the logic unit 304 can permit extension of the rollers 200. Operation (or disabling) of the actuators 302 in response to a signal from the position sensor 317 can be communicated to the user using the alert mechanism 316.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

What is claimed is:

1. A ladder, comprising:
a pair of rails spaced apart from each other;
a set of braces coupled to and extending between the pair of rails; and
a roller assembly, comprising:
a roller coupled with a rail of the pair of rails and movable relative to the rail between a first position and a second position; and
an electronic actuator operable to move the roller from the second position to the first position;
wherein in the first position, the roller extends below a bottom end of the rail; and
wherein in the second position, the roller is retracted relative to the first position.

2. The ladder of claim 1, wherein the electronic actuator comprises a linear actuator.

3. The ladder of claim 1, wherein the electronic actuator is operable to move the roller from the first position to the second position.

4. The ladder of claim 1, further comprising an input device coupled to the ladder, wherein the electronic actuator is controllable by input provided to the input device.

5. The ladder of claim 4, wherein the input device comprises a hand sensor, a capacitive sensor, a current sensor, or a pressure sensor.

6. The ladder of claim 4, wherein the input device comprises an infrared sensor.

7. The ladder of claim 4, wherein the input device comprises a foot switch.

8. The ladder of claim 4, wherein a second roller assembly is coupled with a second rail of the pair of rails, the second roller assembly including a second electronic actuator, and the second electronic actuator is controllable by the input device.

9. The ladder of claim 8, wherein the electronic actuator and the second electronic actuator are simultaneously controllable by the input device.

10. The ladder of claim 1, wherein the roller comprises a caster wheel.

11. The ladder of claim 1, wherein the electronic actuator comprises a motor operable to produce an audible alert or a haptic alert when the roller is moved via the motor.

12. A ladder, comprising:
a rail assembly, including:
a pair of rails spaced apart from each other;
a set of braces coupled to and extending between the pair of rails; and
a logic unit; and
a roller assembly, including:
a roller coupled to the rail assembly and movable relative to the rail assembly between an extended position and a retracted position;
an actuator coupled with the roller and operable, via the logic unit, to move the roller between the extended position and the retracted position.

13. The ladder of claim 12, wherein the logic unit comprises a processor and a computer-readable memory device comprising executable instructions that, when executed by the processor, cause the processor to deploy the roller from the retracted position to the extended position.

14. The ladder of claim 12, wherein the roller is biased toward the retracted position.

15. The ladder of claim 12, wherein the actuator comprises a clutch operable by the logic unit.

16. The ladder of claim 12, wherein the roller is configured to rotate about a vertical axis and the actuator is configured to move the roller between the extended position and the retracted position parallel to an axis non-parallel to the vertical axis.

17. A ladder foot assembly, comprising:
a mount;
a carrier coupled with the mount and movable relative to the mount between a first position and a second position;
a roller rotatably coupled with the carrier and movable with the carrier between the first position and the second position; and
an electronic actuator operable to move the carrier relative to the mount between the first position and the second position.

18. The ladder foot assembly of claim 17, wherein the electronic actuator is configured to linearly move the roller between the first position and the second position.

19. The ladder foot assembly of claim 17, further comprising a sensor in electronic communication with the electronic actuator, wherein the electronic actuator is configured to move the carrier in response to a signal from the sensor.

20. The ladder foot assembly of claim 17, wherein a longitudinal axis of the carrier is configured to be non-vertical when the roller is positioned on a horizontal ground surface.
